(19) United States
(12) Patent Application Publication
(10) Pub. No.: US 2026/0008700 A1
(43) Pub. Date: Jan. 8, 2026

(54) ADIABATIC WATER DESALINATION SYSTEM

(71) Applicant: Arjomand Law Group, PLLC, Issaquah, WA (US)

(72) Inventor: Saeed Towfighi, Gatineau (CA)

(21) Appl. No.: 19/258,745

(22) Filed: Jul. 2, 2025

Related U.S. Application Data
(60) Provisional application No. 63/668,309, filed on Jul. 8, 2024.
(60) Provisional application No. 63/680,582, filed on Aug. 7, 2024.
(60) Provisional application No. 63/684,766, filed on Aug. 19, 2024.

(51) Int. Cl. C02F 1/04; C02F 103/08

(52) U.S. Cl. CPC C02F 1/041; C02F 2103/08; C02F 2201/004

(57) ABSTRACT

Methods and systems are disclosed for easy and cost-effective adiabatic water desalination, producing freshwater and/or potable water from saline sources with minimal energy input. This is achieved by utilizing adiabatic thermodynamic processes to reduce energy consumption compared to conventional methods. The disclosed methods and systems offer sustainable and cost-effective solutions to address freshwater scarcity. In an example of these methods, a saltwater tank with two chambers is rocked back and forth around an axis such that, during each half cycle of rocking, the vapor volume of one chamber expands and the vapor volume of the other chamber shrinks. The expansion of the chambers' vapor volume vaporizes the salt water, and the shrinkage of the chambers' vapor volume causes condensation of the water vapor, which will be collected in a separate tank.

### CROSS-REFERENCE(S) TO RELATED APPLICATION(S)

This utility patent application claims, under 35 U.S.C. § 119, the benefit of the filing date of U.S. provisional patent application No. 63/668,309, filed on Jul. 8, 2024, titled “Adiabatic Water Desalination System,” U.S. provisional patent application No. 63/680,582, filed on Aug. 7, 2024, titled “Adiabatic Water Desalination System,” and U.S. patent application No. 63/684,766, filed on Aug. 19, 2024, titled “Adiabatic Water Desalination System”, the descriptions/specifications of all of which are incorporated herein in their entirety by reference.

### TECHNICAL FIELD

This application relates generally to water desalination systems. More specifically, this application relates to an adiabatic water desalination system that efficiently produces freshwater from saline sources with minimal energy consumption compared to conventional methods, particularly for geographic regions with limited access to freshwater.

### BRIEF DESCRIPTION OF THE DRA WINGS

The drawings, when considered in connection with the following description, are presented for the purpose of facilitating an understanding of the subject matter sought to be protected.

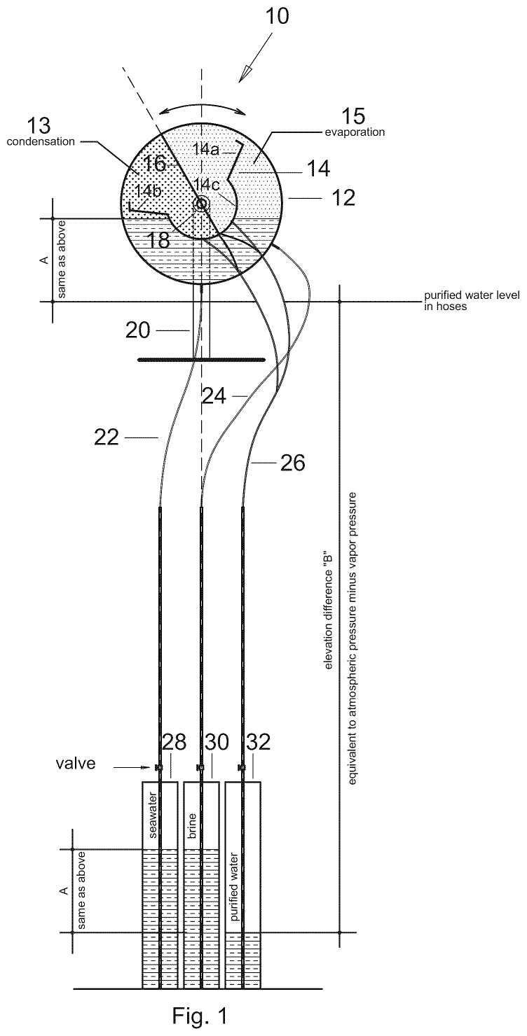

FIG. 1 illustrates an example desalination system;

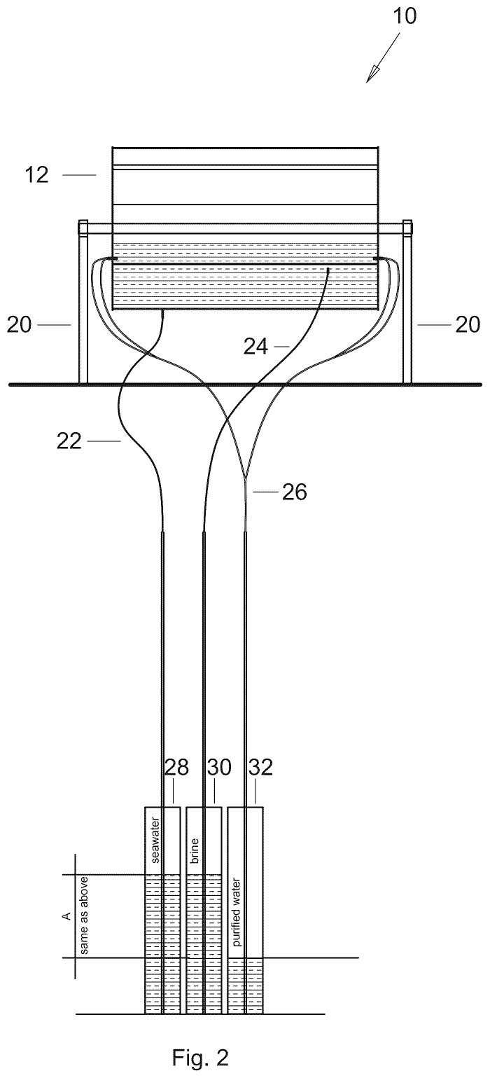

FIG. 2 illustrates a side view of the example desalination system of FIG. 1;

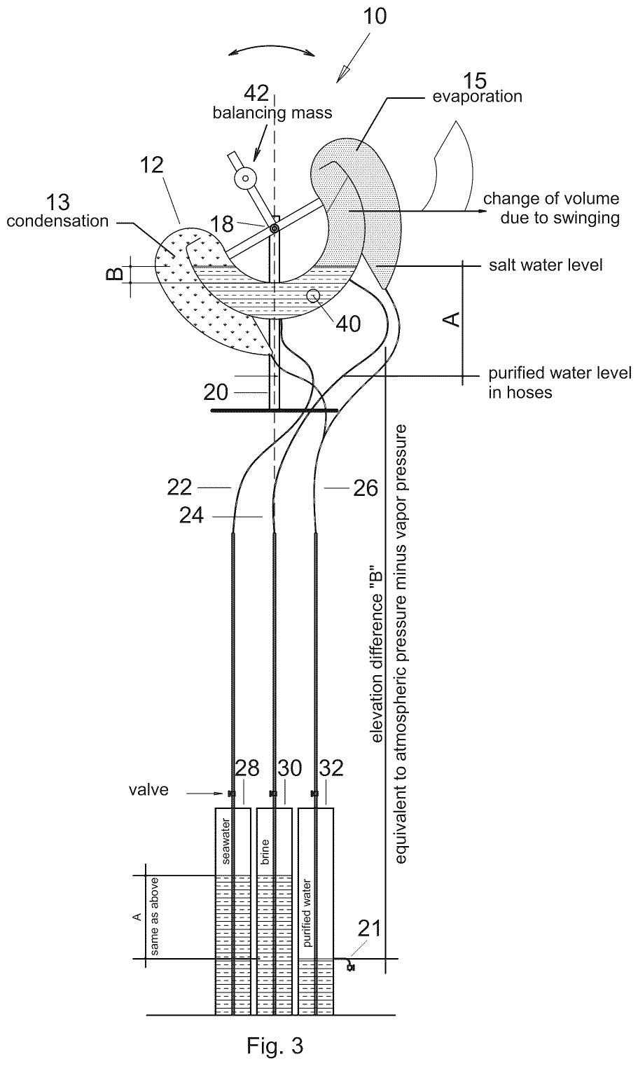

FIG. 3 illustrates another example desalination system;

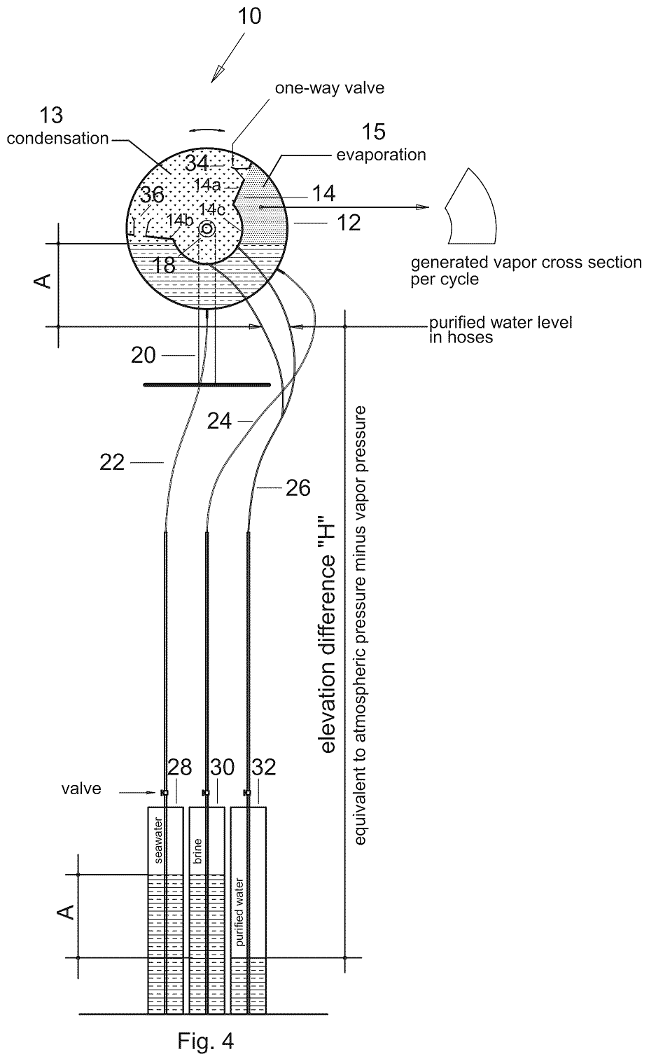

FIG. 4 shows the desalination system of FIG. 1 with some changes;

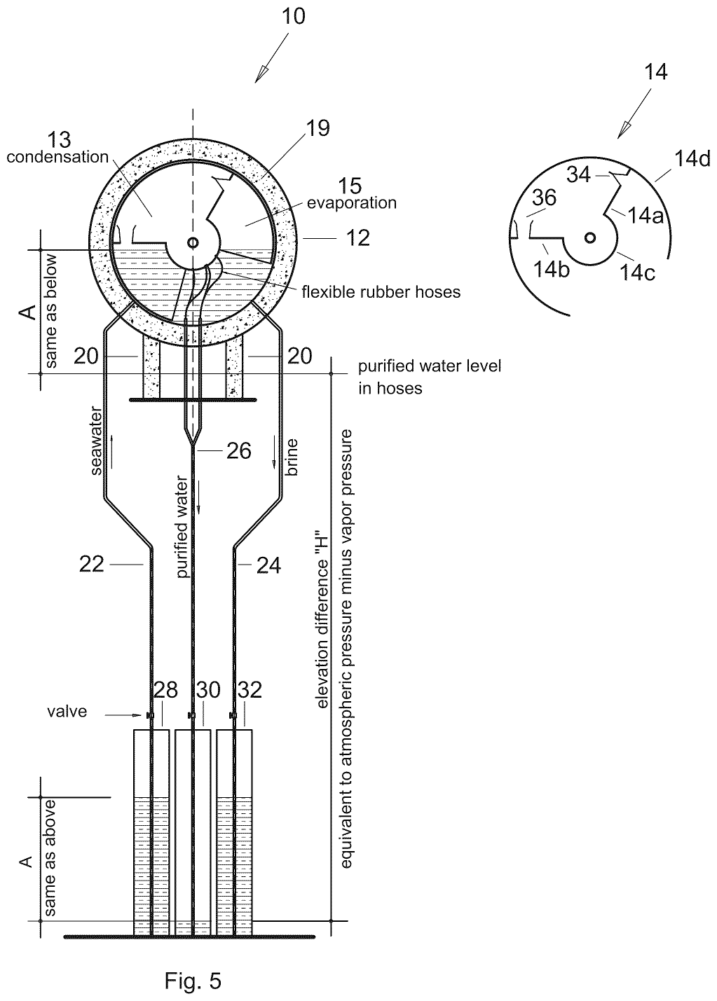

FIG. 5 shows an example desalination system with a stationary outside shell and an oscillating inside assembly; and

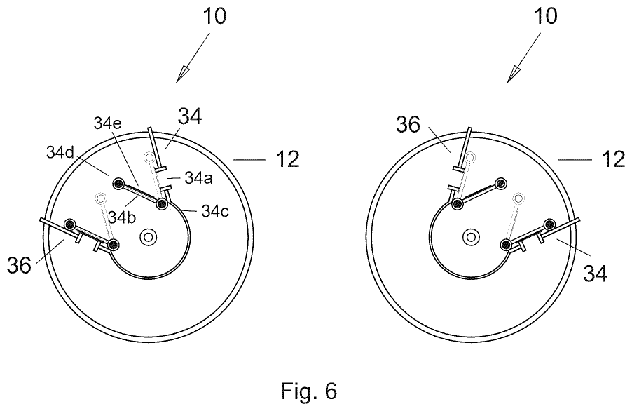

FIG. 6 shows an example one-way valve used in the desalination systems of FIGS. 4 and 5.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

Desalination systems currently used on an industrial scale are primarily Thermal Desalination and Reverse Osmosis (RO). Thermal desalination methods, such as multistage flash distillation (MSF) and multi-effect distillation (MED), are widely adopted for large-scale water production. These systems rely on heating saline water to produce vapor, which is subsequently condensed to yield fresh water. Although effective, they require a substantial energy input, often derived from fossil fuels, resulting in high operational costs and carbon emissions.

Reverse osmosis, on the other hand, utilizes high-pressure pumps to force saline water through semi-permeable membranes, separating salts and impurities. RO has gained significant adoption due to its scalability and lower energy consumption compared to thermal methods. However, the process remains energy-intensive, and the cleaning of the membrane and disposal of brine create significant challenges.

These methods dominate the desalination industry due to their proven reliability and large-scale applicability. However, their energy demands and environmental impacts present a need for alternative solutions that are more energy-efficient and sustainable.

The present disclosure provides an adiabatic water desalination system that operates at a predetermined/desired constant temperature without the presence of air, such that only saturated vapor and liquid water coexist within the system. The system achieves desalination through controlled evaporation and condensation processes.

In some embodiments, evaporation and condensation occur within the same section of the device but in sequential turns. By alternately increasing and decreasing the volume of vapor in the same space, saline water evaporates, and the resulting vapor is condensed in subsequent cycles. This configuration is easy to construct. In such embodiments, the speed at which the volume changes is a function of the speed of droplet formation and the movement of droplets in the device.

In other embodiments, evaporation and condensation take place in separate sections of the device. Saline water is evaporated by increasing the volume of saturated vapor in the evaporation section, and the vapor is transferred to the condensation section, where the volume is decreased to induce condensation. Separating the evaporation and condensation sections, combined with appropriate feeding and drainage mechanisms, enables continuous operation and a higher desalination capacity.

To maintain adiabatic operation and eliminate the need for external heat addition or removal, these embodiments pair evaporation and condensation processes such that the heat released during condensation is directly consumed for evaporation. The configurations of these embodiments ensure that the thermodynamic processes remain adiabatic.

The adiabatic water desalination systems disclosed here can operate at ambient temperatures and do not require heating. However, with increased working temperature, the mass of vapor per unit volume increases, resulting in increased production capacity.

To understand the working mechanism of the system, the basic principles related to water and its saturated vapor pressure are reviewed. According to thermodynamic property tables and charts for saturated water vapor, the saturated vapor pressure is merely a function of temperature. At standard conditions, when water boils at 100° C., the saturated vapor pressure equals atmospheric pressure (1 atm). At lower temperatures, the saturated vapor pressure decreases significantly; for instance, at 40° C., it corresponds to only 7.3% of atmospheric pressure. Because the mass of vapor per unit volume of saturated vapor increases monotonically with temperature, pre-heating may be employed to enhance the system efficiency.

FIG. 1 illustrates an example of the new desalination system. To eliminate air and its pressure in the system of FIG. 1, tank 12, which is connected to the seawater basin 28 through pipes 22, is first filled with seawater, while the other end of pipe 22 is submerged at a desired/calculated lower elevation, compared to the tank 12, in the seawater basin 28. When tank 12 is completely filled with water, releasing water at the lower end of the pipe causes the water surface in tank 12 to stabilize near the mid-height of the tank 12, thereby creating saturated water vapor at the top of tank 12. This condition is achieved when the water pressure (head) created by the elevation difference between the surface of the water basin 28 and the water surface in the tank 12, combined with the saturated vapor pressure, equals the atmospheric pressure, assuming negligible head loss in the pipe 22.

In the example embodiment of FIG. 1, the desalination device has a feeding pipe 22 submerged in the seawater basin 28, an optional brine discharge pipe 24 submerged in an optional brine basin 30, and a third pipe 26 for collecting purified water into the purified water basin 32. For each of these pipes, the same principle and relationship between the corresponding water basin level, the water surface level in the device, and their elevation differences is maintained. This ensures that the pressure inside the device corresponds to the saturated vapor pressure at the system's operating temperature.

In various embodiments, the seawater pipe 22 and brine pipe 24 may be both connected to the same water space within the device to form a siphon. This configuration ensures that by raising the water surface level in the seawater basin 28, a flow is induced and water flows from the seawater basin 28 into the device/tank 12 and from the device into the brine basin 30, removing the thickened saline water from tank 12. The salt in tank 12 increases as a result of the seawater in tank 12 being desalinated and pure water being extracted from it.

The purified water surface within the device can differ from the seawater surface level; therefore, the purified water level in its corresponding basin 32 must be adjusted accordingly to maintain the necessary balance.

The variation in saturated vapor volume at constant pressure and temperature corresponds to the addition or removal of energy to or from the system. However, if these two actions occur simultaneously within the disclosed device, the net effect is theoretically zero heat transfer. To achieve this, vapor expansion occurs in one chamber of the device while vapor contraction occurs simultaneously in another chamber. By alternately repeating this process, the need for heat exchange between the device and the environment is eliminated.

This arrangement requires two separate chambers: one for increasing the volume of saturated vapor and another for decreasing it. For example, to implement the volume changes and pair them with low complexity and high speed, seawater is placed in the space between two concentric partial cylinders, as shown in FIG. 1, with the water surface divided into two parts by the inner cylinder. When these partial cylinders, which are fixed relative to each other, rotate back and forth, they alternately increase and decrease the vapor volume in their corresponding two chambers, each connected to a separate branch of the partial cylinder. It should be noted that upper portion of connecting pipes 22, 24 and 26 may be made of flexible hoses to allow partial rotation of the device.

As shown in FIG. 1, there are two separate condensation chambers, 13 and 15, located on either side of plate 16. Also, the water level in the collecting pipe 26, is lower than the seawater surface but somewhat above the branching point. This prevents the mixing of vapor between the left and right chambers, exposing a very small surface area of the purified water, which is equal to the cross-sectional area of the hose carrying the water.

The inner plate 14 is designed with a circular portion 14c and wings 14a and 14b. Since the seawater level is kept below the wings, the seawater between the lower and upper circular plates would not experience sloshing during the partial cyclic rotation. Therefore, a laminar flow of seawater is anticipated between these curved surfaces, resulting in minimal energy loss due to the viscosity of seawater. It should be noted that the center of rotation is aligned with the longitudinal axis of the cylinders 18.

During the clockwise phase of the cyclic motion/rotation, the volume of the left chamber increases, while the volume of the right chamber decreases, corresponding to evaporation in the left chamber 13 and condensation in the right chamber 15. When evaporation occurs, vapor can form from both the seawater surface and the purified water surface in the collecting hose. However, due to the relatively negligible cross-sectional area of the hose, nearly all evaporation occurs from the seawater surface.

It is understood that water droplets form in the entire volume of the saturated vapor when a reduction in volume takes place. In the portion of the volume below the wings 14a and 14b, the droplets cannot be collected and are lost in the seawater. Of course, as rotation takes place, the portion of the vapor under the wing decreases, thereby with time variation consideration almost half of this volume would be lost during a half cycle. It is clear that increasing the volume above wings 14a and 14b can improve the efficiency of the device.

FIG. 2 shows a side view of the device in FIG. 1. Two posts 20, support shaft 18, which is concentric with both cylinders.

FIG. 3 illustrates another example of the disclosed desalination system, which also includes an optional electric heating element 40, to adjust the working temperature of the device. The example embodiment of FIG. 3 also includes balancing mass 42, which is intended to adjust the swinging period of the device. In this embodiment, the condensation and evaporation chambers 13 and 15, respectively, are located below the seawater space, as shown in FIG. 3. This configuration may be constructed by forming a stainless steel sheet with reduced welding length. Since the device must be completely sealed, this method may reduce the manufacturing cost.

In the example embodiment shown in FIG. 4, the divider plate 16 is eliminated, and the longitudinal passage at the edge of the wings 14a and 14b is replaced with one or more one-way valves 34 and 36. During volume expansion beneath a wing, the corresponding one-way valve must remain closed, and as the rotation reverses direction, the same valve must open. Since local temperature changes are negligible due to the significantly higher mass of the seawater compared to the vapor, and the vapor and seawater are maintained at the same temperature, no pressure change should occur between the condensation chamber 13 and the evaporation chamber 15 below the wings. To meet this requirement, the opening and closing of the one-way valves 34 and 36 cannot depend on the pressure difference between the two sides of the valve along the flow path. Instead, a mechanism that operates based on the orientation of the cylinders relative to the ground is assumed to control the valve states. It should be noted that the one-way valve as shown in FIG. 4 is only schematic. FIG. 6 illustrates a valve example that operates based on the device's orientation with respect to the direction of gravity.

In the embodiment shown in FIG. 4, as the closed state of one valve coincides with the open state of another, the volume reduction beneath a wing would result in some droplets not being collected, similar to the case in the previous embodiment. However, the ratio of the volume above the wing to the volume beneath the wing has increased, which contributes to improving the pure water production capacity of the system. Another advantage of this embodiment is that after the formation of a droplet in the condensation space, it would not be subject to evaporation as the evaporation space is separate. Thereby, almost continuous condensation can take place subject to the speed of operation of the one-way valves. This is expected to increase the device's operational speed and production capacity.

One implementation consideration is the elevation difference between the water basins and the elevated device or tank 12. In some situations, it may be more convenient to increase the working temperature and reduce the required elevation difference H, so that the process can take place with about one story elevation difference. This should also take into account the air pressure at the site based on its elevation above sea level. For example, in Santa Fe, New Mexico, where the city is approximately 2,134 meters (7,000 feet) above sea level, the atmospheric pressure is about 77% of the sea-level value (approximately 78.5 kPa compared to 101.3 kPa). This lowers the equivalent water head for the air pressure to approximately 8.0 meters.

To further reduce the required elevation difference, one may consider working with heated water at 80° C. Since the vapor pressure at 80° C. is about 47.4 kPa, equivalent to a water head of approximately 4.83 meters, the required elevation difference between the source basin and the elevated unit would change to about 3.17 meters. This fits comfortably within a typical one-story building height, making the design practical and efficient for smaller elevation differences.

Alternatively, for configurations where a two-story elevation difference is available, one may consider operating the system with a lower working temperature, such as 60° C. At this temperature, the vapor pressure is approximately 19.9 kPa, equivalent to a water head of about 2.03 meters. Subtracting this from the ambient pressure head of 8.0 meters at the elevation of Santa Fe yields a required elevation difference of about 5.97 meters, which is compatible with a typical two-story structure. This option may be favorable in scenarios with limited heating capacity or where structural elevation is readily available.

To transfer the heated water to the elevated device, the use of centrifugal pumps may face difficulties due to the low available pressure at the pump inlet. Under such conditions, the Net Positive Suction Head (NPSH) required by conventional pumps may not be met, leading to the risk of cavitation and reduced pump performance. As a solution, it is possible to heat the saline water directly inside the elevated device, thereby eliminating the need to pump hot water upward. This can be achieved using encased electrical heating elements or other passive or solar-thermal heating methods integrated into the device structure. Such an approach simplifies the system by eliminating the need for mechanical pumping.

Although a fully cylindrical device offers certain advantages, it may require long sealed welds when fabricated from stainless steel or similar materials. However, the geometry of the device is not restricted to a cylindrical form. For instance, the embodiment shown in FIG. 3 utilizes bent plates, which significantly reduces the total weld length. This alternative construction approach may help lower manufacturing costs.

In FIG. 6, an example one-way valve is illustrated, operating based on the orientation of the device. Wing 34 includes one or more holes or vapor passages 34a, which can be blocked by a hinged lid 34b. The lid pivots around hinge 34c, located at its lower end. At the upper end of the lid, a small weight 34d may be added to apply gentle pressure, ensuring contact between the passage edge and a rubber sealing element 34e, attached to the lid surface, thereby sealing the passage. Hinge 34c has a limited angular range of motion, clearly demonstrated by the open and closed positions shown. When the device changes its orientation, as depicted in the left and right parts of FIG. 6, the lid flips accordingly to either open or close the vapor passages. Of course, various mechanisms for the one-way valve can be used, as well as the commercially available one-way valves.

In various embodiments, the water level in the basins is maintained at certain desired or calculated heights based on the desired working temperature and the elevation difference H. To sustain the proper levels during operation, the saline water level in basin 28 is kept constant. For this purpose, water is continuously supplied during the device's operation, and purified water is generated. A simple feed mechanism suitable for a small-scale device may consist of a slightly elevated, sealed tank connected via a feeding pipe whose lower end touches the water surface in basin 28. Whenever the water level slightly decreases, air bubbles form in the pipe and rise upward into the elevated tank, enabling water flow downward through the feeding pipe. This straightforward mechanism can effectively maintain a constant water level in basin 28. In the purified water basin 32 (FIG. 3), an outlet 21 is positioned at the desired water level to ensure system balance. Excess purified water generated during operation would overflow through this outlet into a collection tank.

For initial setup, air is removed from the system's tank 12. By incorporating control valves and an air release valve at the top of the tank 12, the piping can be temporarily isolated from the basins. The water flowing from the lower points of the tank 12 fills the tank and the piping, completely displacing air and releasing it through a one-way air release valve at the top, thereby fully removing air from the system.

The system's working temperature is assumed to be constant. In reality, temperature fluctuations will occur during operation. To ensure proper water level in the tank, the water surface level in the basins is adjusted in consideration of the working temperature. It should be noted that the rate of change of vapor pressure with temperature is significantly higher around 80° C. compared to that at 50° C. Dimension B, as shown in FIG. 3, is also critical for maintaining a stable working mechanism. The larger this dimension, the greater the system's tolerance for temperature variations.

To illustrate the production capacity numerically, consider the Santa Fe scenario, where the device operates with a one-story elevation difference and saline water is preheated to 80° C. Assume a volume increase with a surface area of 0.3 m², and a length of 2 m, as depicted in FIG. 3. This yields a volume change of approximately 0.6 m³ on each chamber. The condensation chamber is designed similarly, providing another 0.6 m³, resulting in a combined vapor production volume of 1.2 m³ for a full cycle of oscillation.

At 80° C., saturated vapor density is about 333 g/m³. Hence, the initial mass of water vapor generated in half-cycle in a chamber (0.6 m³) is approximately 200 g (0.2 kg). Assuming the same volume for the collectible condensation space, at the end of the volume reduction phase, the combined vapor volume reduces to 0.6 m³, holding about 200 g of vapor. Since condensation droplets form throughout both chambers but only droplets in the condensation chamber (0.6 m³) are collectible, the ratio of collectible vapor mass to total vapor mass changes from 0.5 initially (at maximum volume) to 1.0 at the end of condensation. On average, this ratio is 0.75. Thus, the average collectible vapor per half-cycle of the swinging motion is: 0.75×0.2 kg=0.15 kg. With a swinging cycle period of 3 seconds, there are 20 cycles per minute or 2400 half-cycles per hour. Therefore, the hourly production capacity becomes: 0.15×2400=360 kg/hour. It should be noted that in practice, there will be a small volume above the volume change space where the vapor cannot be collected. This can reduce the device capacity slightly. Moreover, for device dimensions the ratio between the vapor generating space and the collectible part of the condensation space can be optimized for maximum efficiency.

For large-scale implementation, rotating the entire device may not be practical. Instead, in various embodiments, a stationary external shell is constructed from reinforced concrete or another durable material, and an internal assembly is mounted inside the sealed shell that is designed to undergo an oscillatory rotational motion. This internal movement produces synchronized changes in vapor volume, causing alternating phases of evaporation and condensation.

As illustrated in FIG. 5, the interior assembly comprises a movable body 14, which swings within the fixed outer shell 19. This body includes a capped partial cylindrical segment 14d and an upper assembly 14a and 14b, similar to earlier embodiments. The partial cylinder 14d is partially and longitudinally submerged in the saline water and encloses a vapor volume beneath its wings. Oscillation of this internal assembly causes the vapor volume to vary cyclically, enabling alternating evaporation and condensation. Flexible hoses are included inside the tank to allow the discharge of purified water from the oscillating assembly, without requiring external movement or compromising sealing.

One-way valves are employed in the same manner as in smaller-scale designs to ensure correct vapor flow direction during each cycle. The external water basins 28, 30, and 32 remain stationary, as in all other embodiments, and maintain a consistent connection to the device without the need for flexible components. Again, it is worth noting that basin 32 and pipe 24, which are used for removing brine from the tank, are optional.

An implementation detail is the transfer of mechanical motion into the sealed internal volume. In some embodiments, this is achieved by using slightly oversized feed pipes that also serve as passageways for a mechanical shaft. These pipes are continuously filled with water, which inherently seals the shaft against vapor leakage. Standard mechanical means can be applied at the external end of the shaft to generate the required oscillation, which is transmitted to the internal assembly without violating the sealed environment.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. An adiabatic method of desalination, the method comprising:
filling a tank with salt water, wherein surrounding air cannot enter the tank;
draining, passively and partially, the salt water of the tank, through a first pipe, into a salt water basin until vaporized water replaces the partially drained water and water surface stabilizes in the tank, wherein an end of the first pipe is submerged in the salt water basin, and wherein the vaporized water stay in a first and a second noncommunicative chambers of the tank;
rocking the tank periodically such that during a first movement the first chamber's vapor volume expands and simultaneously the second chamber's vapor volume shrinks, and during a second movement the first chamber's vapor volume shrinks and simultaneously the second chamber's vapor volume expands, wherein expansion of the chambers' vapor volume further vaporizes the salt water and shrinkage of the chambers' vapor volume causes condensation of the water vapor;
collecting the condensation of each chamber; and
directing the collected condensation from each chamber to a pure water basin via pure water pipes.

2. The method of claim 1, wherein the salt water basin is positioned lower than the tank.

3. The method of claim 2, wherein water vapor pressure plus a pressure resulting from a water-head between the tank and the salt water basin equals an atmospheric pressure on the basin's salt water surface.

4. The method of claim 1, wherein the salt water stays in a non-divided section of the tank.

5. The method of claim 1, wherein rocking consists of rotational movements.

6. The method of claim 1, wherein as pure water is removed from chambers, salt water is added to the salt water tank to keep height or elevation of the salt water fixed in the tank.

7. The method of claim 1, wherein the salt water of tank is kept at a desired temperature.

8. A desalination system comprising:
a salt water tank rotatable around a horizontal axis passing through the tank;
a divider wall, along the axis of rotation, partitioning a top part of the tank's inside into a first and a second chamber;
a salt water pipe, connected from one end to a lower point of the tank;
a salt water basin as a reservoir of salt water, wherein the other end of the salt water pipe is submerged in the salt water of the salt water basin;
a pure water pipe for removing desalinated water from the tank;
a pure water basin, connected from one end to the tank, wherein the other end of the pure water pipe is submerged in the water within the pure water basin; and
wherein salt water is maintained within the tank at a level that allows the divider wall to remain partially submerged, ensuring the two chambers remain noncommunicative.

9. The system of claim 8, wherein the salt water basin is positioned lower than the tank.

10. The system of claim 8, wherein the divider wall is fixed to the tank or rotates separately around the horizontal axis.

11. The system of claim 10, wherein the tank or the divider wall is rotated back and forth by a motorized or manual mechanism.

12. The system of claim 8, wherein each chamber has a condensation trapping partition.

13. The system of claim 12, wherein the pure water pipe directs condensation from the trapping partition to the pure water basin.

14. The system of claim 8, further consists of a brine water pipe and a brine water basin for removing excessively salted water from the tank.

15. The system of claim 8, wherein all or some of the pipes attached to the tank are flexible.

16. An adiabatic desalination system comprising:
a stationary salt water tank in a shape of a horizontal cylinder;
a partitioning wall, along a longitudinal axis of the salt water tank, partitioning tank's inside into two longitudinal chambers, wherein a cross-section of the partitioning wall is V-shaped and wherein a line at a lowest point of the V-shaped wall coincides with central axis of the salt water tank and wherein the V-shaped wall is configured to rotate about the central axis of the salt water tank.
a salt water pipe, connected from one end to a lower point of the tank;
a salt water basin as a reservoir of salt water, wherein the other end of the salt water pipe is submerged in the salt water of the salt water basin;
a pure water pipe for removing desalinated water from the tank;
a pure water basin, connected from one end to the tank, wherein the other end of the pure water pipe is submerged in the water within the pure water basin; and
wherein salt water is maintained within the tank at a level that allows the lowest line of the V-shaped wall to remain partially submerged.

17. The system of claim 16, wherein the salt water basin is positioned lower than the salt water tank.

18. The system of claim 16, wherein the partitioning wall is rotated back and forth by a motorized or manual mechanism.

19. The system of claim 16, further consisting of a longitudinal separation wall within the partitioning wall.

20. The system of claim 16, further consisting of one-way valves on side-walls of the V-shaped partitioning walls.
